(19) United States
(12) Patent Application Publication
(10) Pub. No.: US 2024/0062137 A1
(43) Pub. Date: Feb. 22, 2024

(54) IMPORT GATEWAY OPTIMIZATION MODEL

(71) Applicant: Target Brands, Inc., Minneapolis, MN (US)

(72) Inventors: KARTHIK RAJPUROHIT, Minneapolis, MN (US); CONG GUO, Minneapolis, MN (US); LIYU ZHENG, Detroit, MI (US)

(73) Assignee: Target Brands, Inc., Minneapolis, MN (US)

(21) Appl. No.: 17/889,193

(22) Filed: Aug. 16, 2022

(51) Int. Cl. G06Q 10/08; G06Q 30/02

(52) U.S. Cl. CPC G06Q 10/0831; G06Q 30/0202

(57) ABSTRACT

The present application describes a method and systems for enterprise supply chain optimization by accounting for time, cost, product demand, capacity constraints, and other factors. The described application relates to solving for the optimal flow of products through a supply chain including overseas vendors and a selected set of import gateways by using a custom-built model based on linear programming techniques. The model described in the present disclosure relates to a model that optimizes the overall cost or time (or a balance of both cost and time) to ship products from origin ports to domestically located distribution centers. By doing so, the model also optimally allocates how shipping containers are sent to domestic ports. The model subsequently outputs the optimal flow, cost, and time for each route in the network, as well as providing other relevant output.

### BACKGROUND

An enterprise may import products from vendors in overseas nations. These products may be shipped from, and to, many different ports. When the products arrive at designated domestic ports, they may be processed by a deconsolidator, or “Decon,” which may break down a shipment into smaller shipments. Following deconsolidation, the smaller shipments of products may be shipped to multiple distribution centers owned or controlled by the enterprise, often by truck or rail. From these distribution centers, products may be then sent on to other distribution centers, stores, or final delivery points within the enterprise, or at enterprise customer locations.

A final distribution center or other delivery point may require products from only a portion of a shipment, products from an entire shipment, or products from a portion of multiple shipments. Each overseas vendor may be scheduled to ship, via an overseas port, a volume of products. Each route from one of these product origins or destinations (for example, from an overseas port to a domestic port, or from a deconsolidator to a distribution center), has an associated cost and lead time. Routes, origin points, and destination points, all may have constraints (for example, a type of product that can be received or a volume of product that can be moved). Route lead times and costs may vary from one route to another and may also vary over time due to a variety of complex factors, including seasonal demand of various products and conflicts caused by that demand when combined with capacity constraints at each node within the above-described supply chain. Product requirements and vendor shipping volumes may also vary from one to another and may vary over time for many reasons. Because of these variations, it may be difficult for an enterprise to efficiently optimize its supply chain. A system which creates optimized routes, taking into account product requirements, shipping volumes, constraints, and other factors to meet optimization goals such as cost and lead time may have significant benefits to the enterprise, including cost, timing, efficiency, and customer satisfaction.

### SUMMARY

In general, the present disclosure relates to enterprise supply chain optimization. In particular, the invention of the present disclosure, by accounting for time, cost, product demand, capacity constraints, and other factors, solves for the optimal flow of products through a supply chain including overseas vendors and a selected set of import gateways by using a custom-built model based on linear programming techniques. The model described in the present disclosure relates to a model that optimizes the overall cost or time (or a balance of both cost and time) to ship products from origin ports to domestically located distribution centers. By doing so, the model also optimally allocates how shipping containers are sent to domestic ports. The model subsequently outputs the optimal flow, cost, and time for each route in the network, as well as providing other relevant output.

Accordingly, the present application describes a computing system, which may include at least one processor and at least one memory storing computer-executable instructions for optimizing overseas freight routing from a plurality of overseas vendors to a plurality of domestic distribution centers of a retail enterprise through one or more of a plurality of gateways. In some examples, the computer-executable instructions, as executed by the at least one processor, may cause the computer to receive a plurality of data inputs from disparate data sources within an enterprise supply chain. The plurality of data inputs may include comprise: a definition of each node of a plurality of nodes within the enterprise supply chain, the plurality of nodes including the plurality of overseas vendors, the plurality of gateways, and the plurality of domestic distribution centers, where each definition may include a geographic region and an active status of the node; route costs associated with each of a plurality of routes (including routes between the plurality of overseas vendors and each of the plurality of gateways; and routes between a plurality of deconsolidators and the plurality of domestic distribution centers, where each deconsolidator is associated with one of the plurality of gateways); lead times associated with each of the plurality of routes; one or more shipping constraints (which may be associated with at least one route of the plurality of routes and/or at least one gateway of the plurality of gateways; at least one domestic distribution center of the plurality of domestic distribution centers; or at least one deconsolidator of the plurality of deconsolidators) origin port product volume data representative of a schedule of retail goods provided by one or more of the plurality of overseas vendors; and demand volume data indicative of a portion of the origin port product volume required to be received at one or more of the plurality of domestic distribution centers. In some examples, the instructions may also cause the computer to execute an optimization process by determining a solution, via a linear solver model, based on the plurality of data inputs to generate a routing solution that is optimized to satisfy at least one user-selectable optimization goal and output (on an origin node to destination node basis) for each of a plurality of origin node to destination node pairs within the enterprise supply chain, a plurality of data outputs. In some examples, the plurality of data outputs may include, as part of the routing solution: a set of origin node to destination node pairs including an optimized set of shipments through the plurality of gateways and accounting for the one or more shipping constraints including capacity constraints of the at least one gateway of the plurality of gateways; cost data associated with the routing solution; and/or lead time data associated with the routing solution. In some examples, an optimized overseas freight strategy may be determined, based on the routing solution.

In some examples, a disclosed computing system may include at least one processor and at least one memory storing computer-executable instructions for optimizing overseas freight routing from a plurality of overseas vendors to a plurality of domestic distribution centers of a retail enterprise through one or more of a plurality of gateways. In some examples, the computer-executable instructions, when executed by the at least one processor, may cause the computer to receive a plurality of data inputs from disparate data sources within an enterprise supply chain, where the plurality of data inputs may include: a definition of each node of a plurality of nodes within the enterprise supply chain, the plurality of nodes including the plurality of overseas vendors, the plurality of gateways, and the plurality of domestic distribution centers, wherein each definition includes a geographic region and an active status of the node; route costs associated with each of a plurality of routes (including routes between the plurality of overseas vendors and each of the plurality of gateways; and routes between a plurality of deconsolidators and the plurality of domestic distribution centers, where each deconsolidator is associated with one of the plurality of gateways); lead times associated with each of the plurality of routes; one or more shipping constraints (which may be associated with at least one route of the plurality of routes; at least one gateway of the plurality of gateways; at least one domestic distribution center of the plurality of domestic distribution centers; or at least one deconsolidator of the plurality of deconsolidators); origin port product volume data representative of a schedule of retail goods provided by one or more of the plurality of overseas vendors; and/or demand volume data indicative of a portion of the origin port product volume required to be received at each of the plurality of domestic distribution centers. In some examples, the computer-executable instructions may cause the computer to: predict a plurality of alternative data inputs based on past freight routing performances; modify one or more of the plurality of data inputs based on the plurality of alternative data inputs to generate a plurality of modified data inputs; execute an optimization process by providing the modified plurality of data inputs to a linear solver model to generate a routing solution that is optimized to satisfy at least one user-selectable optimization goal; and output (on an origin node to destination node basis) for each of a plurality of origin node to destination node pairs within the enterprise supply chain, a plurality of data outputs. The data outputs may include an optimized set of shipments through the plurality of gateways and accounting for the one or more shipping constraints; cost data associated with the routing solution; and lead time data associated with the routing solution. An optimized overseas freight strategy may be determined, based on the routing solution.

In some examples, a method for optimizing freight routing may include receiving a plurality of data inputs from disparate data sources within an enterprise supply chain. The plurality of inputs may include: a plurality of nodes; a cost associated with each of the plurality of nodes (in some examples, the cost may include a handling cost associated with a corresponding one of the plurality of nodes) and a node capacity constraint associated with each of a selected set of the plurality of nodes being representative of a group of selected gateways, the node capacity constraint being a capacity constraint of each of a set of deconsolidators associated with the selected set of the plurality of gateway nodes. In some examples, the method may include defining a plurality of arcs, each arc defining a route among two or more nodes of the plurality of nodes, each of the plurality of arcs defining the route including a gateway node of the plurality of gateway nodes. An arc cost for each of the plurality of arcs may be determined, and an arc time defining a time of movement of items through each of the one or more arcs in accordance with a transit mode of the items may be determined. A time period for which to perform an optimization process may also be determined, and a product percentage of items to route through each deconsolidator of the set of deconsolidators may be calculated. In some examples, the method may also include determining a demand associated with each of a plurality of pairs of product origin ports and destination warehouses during the time period, and applying an optimization model to obtain an optimized solution for routing items during the time period through the plurality of arcs, the optimized solution having a selectable goal from a plurality of configurable objectives, the plurality of configurable objectives including minimizing total costs and minimizing total lead times, the optimization model being a multivariable linear optimization model. In some examples, total costs may include total transportation costs associated with each of the plurality of arcs and total node variable costs associated with each of the plurality of arcs. In some examples, total lead times comprise arc times for each of the plurality of arcs. In some examples, applying the optimization model includes applying one or more constraints to the model prior to applying the optimization model (in some examples, the constraints may include the node capacity constraint; and a flow-conservation constraint associated with each of the plurality of nodes, the flow-conservation constraint comprising one or more of: source constraints associated with one or more of the plurality of nodes which ae a source of items; intermediate constraints associated with a desired minimum flow through one or more of the plurality of nodes; and demand constraints associated with one or more of the plurality of nodes which are a destination of items). In some example, the method may include generating one or more output files defining the optimal solution, the output file comprising a detailed optimized flow of items through the plurality of arcs, and storing the one or more output files to an optimized solution database.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system for optimizing the flow of products from overseas vendors through domestic gateways of the supply chain of an enterprise, according to an example.

FIG. 1A further illustrates the example figure of FIG. 1, wherein product flow from domestic gateways through various nodes is optimized, according to an example.

FIG. 2 illustrates an example system for optimizing the flow of products from overseas vendors through domestic gateways of the supply chain of an enterprise, comprising an order management system software model and a user interface, according to an example.

FIG. 3 illustrates an example method for optimizing the flow of products from overseas vendors through domestic gateways of the supply chain of an enterprise, according to an example.

FIG. 4 an example method of optimizing a supply chain product route as carried out by an order management system software model, according to an example.

FIG. 5 illustrates an example output display of an optimized supply chain routes as optimized by an order management system software model, according to an example.

FIG. 6 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

An enterprise may import products from vendors in overseas nations. These products may be shipped from many different ports. When the products arrive at designated domestic ports, they may be processed by a deconsolidator, or “Decon,” which may break down a shipment into smaller shipments. Following deconsolidation, the smaller shipments of products may be shipped to multiple distribution centers, often by truck or rail. From these distribution centers, products may be then sent on to other distribution centers, stores, or final delivery points. Although this disclosure may be applicable to many shipping phases of an enterprise supply chain, the examples herein focus primarily on three shipping phases: (1) from overseas origin ports to domestic ports (gateways); (2) from gateways to Decons; and (3) from Decons to distribution centers. Because different start and end locations can be mixed and matched, there may be numerous possible routes within each shipping phase.

A distribution center or other delivery point may require products from only a portion of a shipment, products from an entire shipment, or products from a portion of multiple shipments. Each overseas vendor may be scheduled to ship, via an overseas port, a volume of products. Each route from one of these product origins or destinations (for example, from an overseas port to a domestic port, or from a deconsolidator to a distribution center), has an associated cost and lead time. Routes, origin points, and destination points, all may have constraints (for example, a type of product that can be received or a volume of product that can be moved). Route lead times and costs may vary from one route to another and may also vary over time due to a variety of factors. Product requirements and vendor shipping volumes may also vary from one to another and may vary over time for many reasons. Because of these variations, it may be difficult for an enterprise to efficiently optimize its supply chain. A system which creates optimized routes, taking into account product requirements, shipping volumes, constraints, and other factors to meet optimization goals such as cost and lead time may have significant benefits to the enterprise, including cost, timing, efficiency, and customer satisfaction.

The model described herein relates to a model that optimizes the overall cost or time (or a balance of both cost and time) to ship volumes of products from origin ports to domestically located distribution centers. By doing so, the model also optimally allocates how shipping containers are sent to domestic ports (gateways). The model requires input data, some of which may be received from sources within the enterprise and some from sources external to the enterprise.

The model requires input data, some of which may be received from sources within the enterprise and some from sources external to the enterprise. These inputs may include nodes, costs, times, constraints, product shipping volume, product demand, or others. Each location in the supply chain is a node; each node may be an origin port (e.g. an overseas port), a gateway (e.g. a domestic port), a Decon, or a distribution center. Each may be associated with information such as its geographic region, subtype, name, or status indicating whether it is currently active. There are hundreds of possible routes between nodes. For each route, there is a cost and an amount of time required to ship products along the route. The data can also indicate the transportation means used on each route, such as truck, train, vessel, or other means. The cost and time for each route may also change over time. Each Decon (associated with a gateway) also may have an associated cost, and a required time for moving products through it. There may be myriad constraints for each node and route. For example, a gateway may have a minimum or maximum number of containers or container volume that it can receive, a Decon may have a maximum number of products that it can move, or a distribution center may only be able to accept certain types of products. Additional input data may relate to origin port product shipping volume, which may include a schedule of the number and volume of containers that each origin port is sending and may be broken down by different timeframes (for example, by day, week, or month). Distribution center product demand data may relate to the amount of product (for example, by volume) required at each distribution center. In some examples, the data is expressed as a portion of a shipping container.

Once the model has received the data inputs, it can optimize cost, time, or a combination of cost and time and may determine, given the constraints and other input data, the cheapest or fastest way to send products from origin ports, to gateways, through numerous shipping phases, and eventually to distribution centers. In the optimization process, the model may use linear programming equations.

The model can output data related to the optimal routing solution. For example, the model can output the optimal container volume sent on each route and what the cost and time are for doing so. This data can then be separated, aggregated, or arranged for analysis. For example, the data can be arranged to show the optimal total cost or time for products shipped to a particular geographic region or over a certain time frame. Furthermore, the data can show the optimal inflow of each gateway; that is, the data can show the container volume that each gateway should receive, and where those containers should come from.

Because constraints, lead times, costs, and other input data may change over time, the model can also be rerun with different inputs. For example, in one iteration, the model can be run with a five gateways, and the results from that iteration can be compared to the results when the model is run with only four gateways. Any of the input data may be altered to run the model for different scenarios. By comparing the outputs from different scenarios, a user may determine how a given change impacts each route of the supply chain, thereby seeing the benefits and overall effects of the change. Users can then use this output data when making strategic investment decisions, such as when determining whether to open a new gateway, or when negotiating with third-party shipping carriers.

In example implementations, the output of the model can be provided, either automatically or on an as-needed basis, to an overseas supply chain management and tracking application. The output of the model may include a selection of specific routes for particularized shipments and may dictate downstream operation of such a supply chain management system in a manner that is more efficient, since it reduces the extent or frequency of rerouting decisions that would otherwise need to be performed by such downstream software.

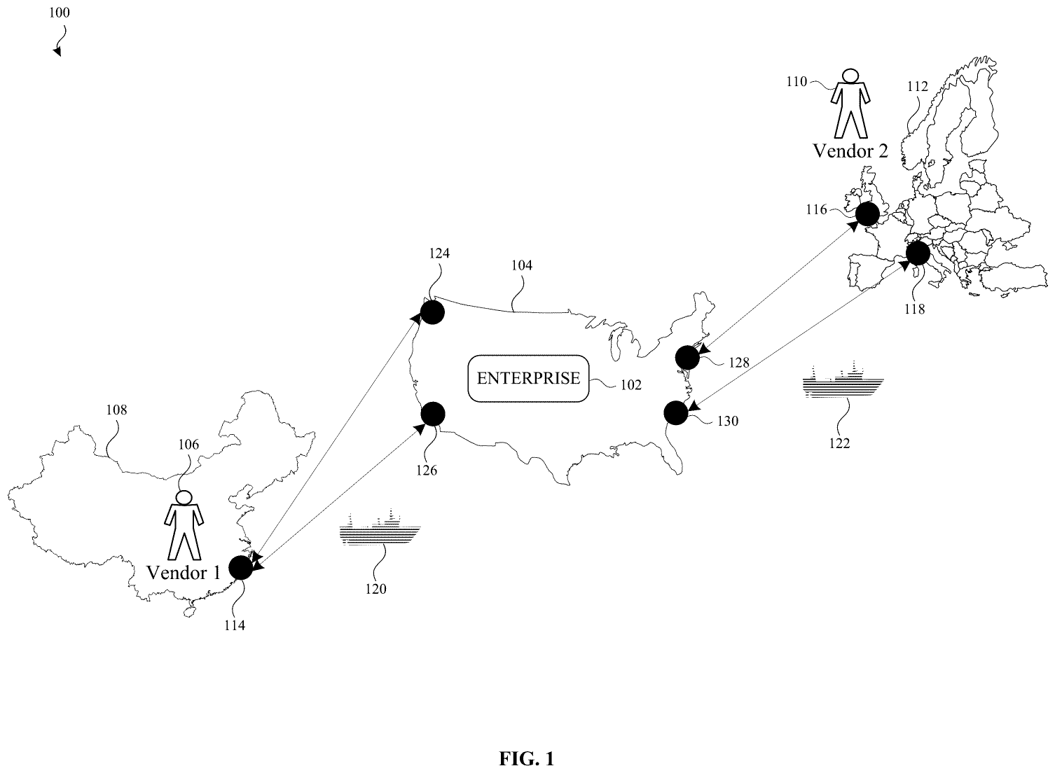

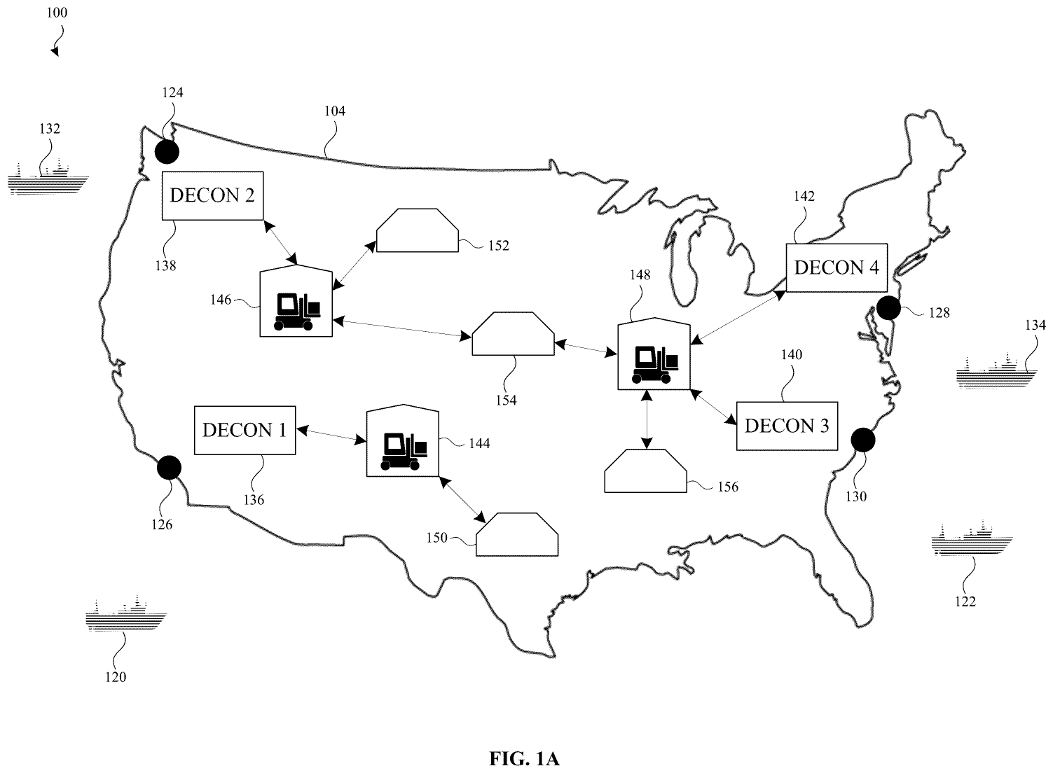

These and other examples will be explained in more detail below with respect to FIG. 1-FIG. 5.

FIG. 1 illustrates an example system for optimizing the flow of products from overseas vendors through domestic gateways of the supply chain of an enterprise, according to an example. FIG. 1 illustrates an example system 100 for receiving and analyzing metrics and data across a plurality of heterogenous databases allocated to different groups within an enterprise, according to an example. As will be described in more detail below, the system 100 may include an enterprise 102 located within a domestic nation 104, an overseas vendor 1 106 located within an overseas nation 1 108, an overseas vendor 2 110 located within an overseas nation 2 112, origin ports 114,116,118, cargo ships 120,122, and gateways 124,126,128,130.

In an example, enterprise 102 may be company or business with at least part of its supply chain located in a domestic nation 104. In an example, enterprise 102 may be company or business based in domestic nation 104. In an example, enterprise 102 may be a retail company which operates retail stores. In an example, domestic nation 104 may be the United States of America. In some examples, enterprise 102 may require a supply of goods from one or more overseas vendors such as vendor 1 106 or vendor 2 110.

In some examples, vendor 1 and vendor 2 may be product suppliers, distributors, manufacturers, growers, packagers, processors, or couriers. In some examples, there may be multiple vendors from an overseas nation (such as overseas nation 1 108 or overseas nation 2 112). In some examples, each of these vendors may supply products to overseas ports. For example, vendor 1 106 may supply products for shipment to origin port 114. In another example, vendor 2 110 may supply products for shipment to origin port 116 and/or origin port 118. Products may be supplied to the origin ports 114,116,118 by truck, van, rail, air, manual transport, water transport, or any other appropriate means of goods transportation.

In some examples, products may be transported by sea from the origin ports 114,116,118 to gateways 124,216,128,130 via cargo ships 120,122. In some examples, cargo ships 120,122 may be representative of any appropriate method of moving products over a large body of water, including cargo vessels, bulk vessels, tankers, livestock vessels, refrigerated vessels, freighters, barges, container ships, feeder vessels, airplanes, jets, or other appropriate water or air vessels. In an example, cargo ship 120 may carry products supplied by vendor 1 106 from origin port 114 on a route to gateway 124. In an example, cargo ship 120 may carry products supplied by vendor 1 106 from origin port 114 on a route to gateway 126. In an example, cargo ship 122 may carry products supplied by vendor 2 110 from origin port 116 on a route to gateway 128. In an example, cargo ship 122 may carry products supplied by vendor 2 110 from origin port 118 on a route to gateway 130. Overseas nations 108,112 may have multiple ports by which to send goods, and domestic nation 104 may have multiple gateways (ports) by which to receive goods, so many routes may be possible for cargo ships 120,122.

In an example, products are loaded into shipping containers (for example, steel containers, refrigerated, heated, or frozen containers, open-top contains, high containers, custom containers, tank containers, open side containers, tunnel containers, flat rack containers, tunnel containers, insulated containers, or other appropriate containers) and then loaded on to cargo ships 120,122. In some examples, product quantity may be measured in terms of fractions of a shipping container.

In some examples, gateways 124,126,128,130 may be domestic ports. In some examples, gateways 124,126,128,130 may be a cargo or freight airport.

FIG. 1A further illustrates the example figure of FIG. 1, wherein product flow from domestic gateways through various nodes is optimized, according to an example. As will be described in more detail below, the system 100 may further include cargo ships 120,122,132,134, gateways 124,126,128,130, Decon 1 136, Decon 2 138, Decon 3 140, Decon 4 1342, and multiple distribution centers 144,146,148, and multiple stores 150,152,154,156.

Cargo ships 120,122,132,134 may take one of multiple available routes to deliver products to gateways 124,126,128,130. In some examples, each gateways 124,126,128,130 is associated with a Decon. In one example, cargo ship 132 may deliver products to gateway 124, which is associated with Decon 2 138. In one example, cargo ship 120 may deliver products to gateway 126, which is associated with Decon 1 136. In one example, cargo ship 122 may deliver products to gateway 130, which is associated with Decon 3 140. In one example, cargo ship 134 may deliver products to gateway 128, which is associated with Decon 4 142. In some examples, the Decons are located within the gateways that they are associated with. In other examples, the Decons are a third-party contractor located at the gateways that they are associated with. In some examples, the Decons 136,138,140,142 break the large shipments of products from cargo ships 120,122,132,134 into smaller shipments that are more suitable for domestic travel routes. In some examples, domestic travel routes may move products by road (for example, truck, van, etc.), rail, air, or waterway.

In some examples, products are moved on routes from Decons 136,138,140,142 to various distribution centers 144,146,148. In some examples, distribution centers 144,146,148 may include warehouses, flow centers, fulfillment centers, flow centers, receive centers, or other appropriate types of distribution center. In some examples, distribution centers 144,146,148 may be representative of many distribution centers of the enterprise. Therefore, there are many (in some examples, hundreds of) possible routes of product shipment from Decons 136,138,140,142 to distribution centers 144,146,148. Each of distribution centers 144,146,148 may have a demand related to the amount of product (for example, by volume of shipping container) required at each distribution center. In some examples, the demand is expressed as a portion of a shipping container. In some examples, the demand is expressed in volumes of full shipping containers.

From distribution centers 144,146,148, the products may be sent along routes to other destinations, such as stores 150,152,154,156, homes, or businesses, for example. In an example, products may be shipped along a route from Decon 1 136 to a single distribution center 144, and then to a single store 150. In an example, products may be shipped along a route from Decon 2 138 to a single distribution center 146, and then to multiple stores 152,154 via different routes. In an example, products may be shipped along a route from multiple Decons (such as Decon 3 140 and Decon 4 142) to multiple or a single distribution center 148, and then on to multiple stores 154,156. In some examples, a store 154 may receive products from multiple distribution centers 146,158.

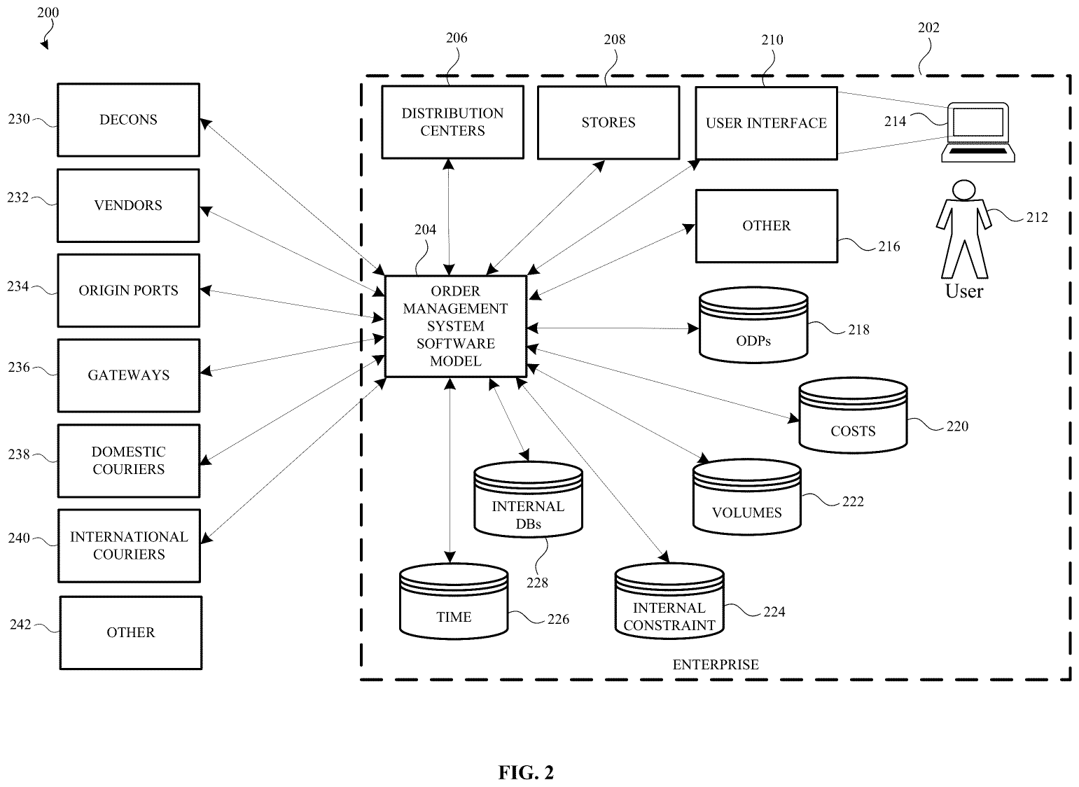

FIG. 2 illustrates an example system for optimizing the flow of products from overseas vendors through domestic gateways of the supply chain of an enterprise, comprising an order management system software model and a user interface, according to an example. As will be described in more detail below, the system 200 may include an enterprise 202, which may have within it: an order management system software model (hereinafter “the model”) 204, distribution centers 206, stores 208, a user 212, a device 214 accessible by the user, other internal entities 216, origin-destination pair (ODP) database 218, cost database 220, volume database 222, internal constraint database 224, time database 226, and other internal databases 228. System 200 may include Decons 230, Vendors 232, Origin Ports 234, Gateways 236, Domestic Couriers 238, International Couriers 240, and other external entities 242.

In some examples, the model 204 may be a mathematical model. In some examples, the model 204 may be based on linear programming techniques. In some examples, the model 204 may receive data inputs from one or more distribution centers 206, such as a distribution center product demand, which may be defined in terms of origin port product volume required to be received at each of the distribution centers 206, in some examples. In some examples, data inputs may include the number of distribution centers 206. In some examples, data inputs may include status indicating whether each of the distribution centers 206 is currently active. In some examples, data inputs may include a geographical area or location of each of the distribution centers 206. In some examples, the model 204 may receive data inputs from one or more stores 208, such as a store product demand, which may be defined in terms of origin port product volume required to be received at each of the store 208, in some examples. In some examples, data inputs may include the number of stores 208. In some examples, data inputs may include status indicating whether each of the stores 208 is currently active. In some examples, data inputs may include a geographical area or location of each of the stores 208. In some examples, the model 204 may receive input data from other internal entities 216, which may include product demand data, constraint data, location data, count data, or other appropriate data as necessary for optimization by the model 204.

In some examples, the model 204 may receive data inputs from one or more databases within the enterprise 202. In some examples, the model 204 may receive data inputs from ODP database 218, which may include, in some examples, a number of possible ODPs based on a number of nodes, definition of the possible ODPs, the possible routes corresponding to the ODPs, or other appropriate data inputs. In some examples, the model 204 may receive data inputs from costs database 220, which may include, in some examples, costs associated with nodes (for example, overseas vendors 232, origin ports 234, gateways 236, distribution centers 206, or stores 208, domestic couriers 238, or international couriers 240), costs associated with routes, or other appropriate costs. In some examples, the model 204 may receive data inputs from volumes database 222, which may include, in some examples, demand volume data, origin port product volume, or other appropriate volumes. In some examples, the model 204 may receive data inputs from internal constraint database 224, which may include, in some examples, constraints associated with distribution centers 206 (for example, ability or inability to accept a specific type of product, volume throughput capacity, volume storage capacity, operating hours or other flow-conservation or capacity constraints), constraints associated with stores 208 (for example, ability or inability to accept a specific type of product, volume storage capacity, operating hours or other flow-conservation or capacity constraints), or constraints associated with routes (for example, route capacity constraints, the size and type a road/rail associated with a route, route accessibility due to time of year/weather/construction, route tolls or fees, route product size or type constraints, or other flow-conservation or capacity constraints), or other appropriate internal constraints. In some examples, the model 204 may receive data inputs from time database 226, which may include lead time to travel a route, lead time for processing or handling of products at a node, or other time-related information pertinent to the optimization.

In some examples, the model 204 may receive data inputs from one or more databases external to enterprise 202. In some examples, the model 204 may receive data inputs from Decons 230, which may include, in some examples, flow-conservation constraints, capacity constraints, ability or inability to handle a product type, location, business relation to enterprise 202, business relation to gateways 236, cost data, time data, route data from Decons 230 to distribution centers 206, or other relevant input data. In some examples, the model 204 may receive data inputs from vendors 232, which may include, in some examples, origin port product volume, cost data, time data, route data from Vendors 232 to origin ports 234, product type, vendor location, number of vendors, or other relevant input data. In some examples, the model 204 may receive data inputs from origin ports 234, which may include, in some examples, number/quantity, location or geographic area, costs, lead time (for loading of vessels, inspections, etc.), route information from the origin ports 234 to gateways 236, flow-conservation constraints, capacity constraints, ability or inability to handle a certain type of product, scheduling constraints, or other relevant input data. In some examples, the model 204 may receive data inputs from gateways 236 (for example, domestic ports or freight airports), which may include, in some examples, number/quantity, location or geographic area, costs, lead time (for unloading of vessels, inspections, etc.), flow-conservation constraints, capacity constraints, ability or inability to handle a certain type of product, scheduling constraints, or other relevant input data. In some examples, the model 204 may receive data inputs from domestic couriers 238 (for example, trucks, vans, trains, barges, or airplanes), which may include, in some examples, cost, flow-conservation constraints, capacity constraints, ability or inability to handle a certain type of product, scheduling constraints, or other relevant input data. In some examples, the model 204 may receive data inputs from international couriers 240 (for example, cargo ships or airplanes), which may include, in some examples, cost, flow-conservation constraints, capacity constraints, ability or inability to handle a certain type of product, scheduling constraints, or other relevant input data. In some examples, the model 204 may receive data inputs from other outside entities, which may include, in some examples, constraint data, cost data, time data, and any other input data relevant to optimization.

In some examples, databases may be allocated in whole or in part to a plurality of enterprise group sand may process and store different types of data and may be supplied from different vendors. In some examples, various databases are virtual (e.g. cloud-based); in other examples, they are network or drive-based.

In some examples, data inputs may be automatically relayed to the model 204. In some examples, data inputs may be provided to the model 204 by a User 212. In some examples, the model 204 may perform continuous, automated optimization. In other examples, the model 204 may perform optimization at the initiation of User 212.

In some examples, once the model 204 has received the necessary data inputs, it may optimize the optimize cost, time, or a combination of cost and time and may determine, given the constraints and other input data, the cheapest or fastest way to send products from origin ports 234, to gateways 236, and eventually to distribution centers 206 (and in some examples, then to stores 208). In the optimization process, the model 204 may use linear programming equations. In the optimization process, the model 204 may optimize to at least one user-selectable optimization goal. In some examples, the user-selectable optimization goal is cost minimization or lead time minimization. In some examples, the user-selectable optimization goal may include meeting demand volume. In some examples, the user-selectable optimization goal may include balancing cost minimization and lead time minimization, so that the optimized routing solution may not have the lowest possible cost or lowest possible route, but may instead provide a benefit to both, for example, in a situation where ultimate cost minimization results in higher lead times, or vice versa.

In some examples, the model 204 can output data related to the optimal routing solution to a user interface 210, which may be displayed on device 214 and viewed by User 212. In some examples, device 214 may be a desktop computer, a laptop computer, a tablet, a cell phone, a smart TV, a smart wearable device, or other appropriate electronic device which is capable of displaying the user interface 210. In an example, User 212 is an engineer, operator, logistics coordinator, or other agent of the enterprise. In an example, user interface 210 is a web application. In other examples, user interface 212 is a device application. In some examples, user interface 210 is a spreadsheet. In some examples, user interface 210 allows User 212 to interact with displayed tables, graphs, or other appropriate display means to better view the data based on User 212's needs and preferences (for example, filtering, sorting, customizing views and charts, or toggling different options on and off).

In some examples, lead times, costs, and other input data from various sources may change over time, the model 204 can also be rerun with different data inputs. For example, in one iteration, the model 204 can be run with five gateways 236, and the results from that iteration can be compared to the results when the model is run with six gateways 236. In some examples, any of the input data may be altered to run the model 204 for different scenarios. In some examples, the outputs (as displayed via user interface 210) from different scenarios may be compared, and User 212 user may determine how a given change impacts each route of the supply chain, thereby seeing the benefits and overall effects of the change. In some examples, User 212 may then use this output data as displayed on user interface 210 when making strategic investment decisions, such as when determining whether to open a new gateway, change from one gateway to another, choose a different route, eliminate a gateway, or when negotiating with third-party shipping carriers (such as domestic couriers 238 or international couriers 240).

In some examples, communications between the model 204 and the entities and databases of the enterprise, as well as communications between the model 204 and the entities external to the enterprise, may occur via one or more networks. In some examples, the networks may include a computer network, an enterprise intranet, the Internet, a LAN, a Wide Area Network (WAN), wireless transmission mediums, wired transmission mediums, other networks, and combinations thereof.

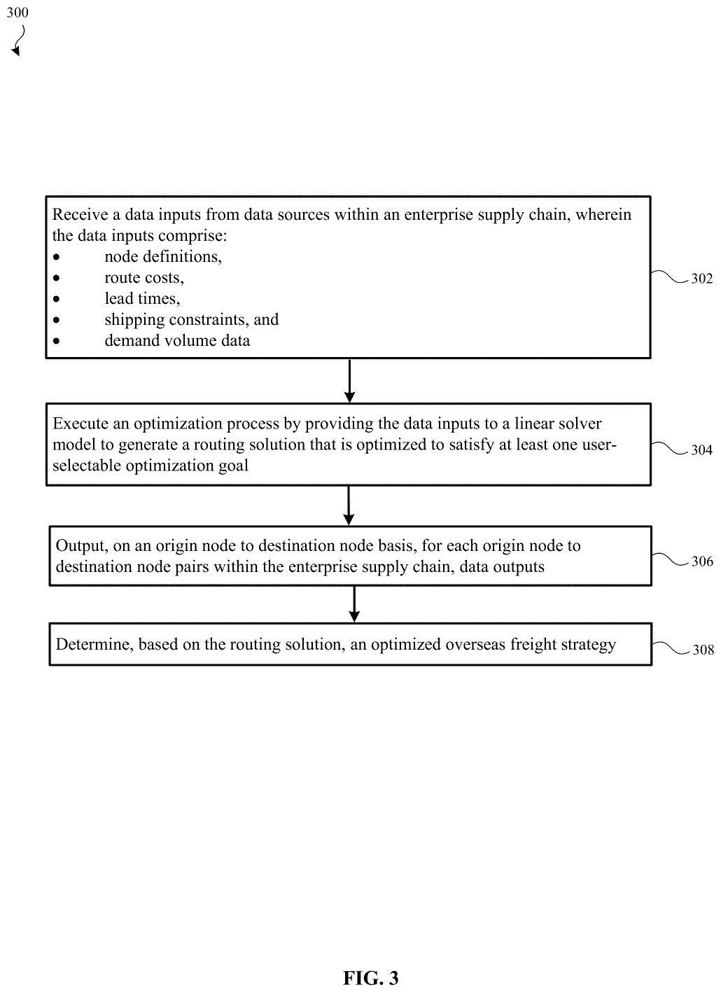

FIG. 3 illustrates an example method for optimizing the flow of products from overseas vendors through domestic gateways of the supply chain of an enterprise, according to an example. As will be described in more detail below, the method 300 may include steps 302, 304, 306, and 308. A computing system (which may comprise a processor and a memory storing computer-executable instructions) may optimize overseas freight routing from a plurality of overseas vendors to a plurality of domestic distribution centers (for example, distribution centers, warehouses, flow centers, etc.) of an enterprise (for example, a retail enterprise) through one or more of a plurality of gateways (for example, domestic ports or freight airports). In some examples, this optimization may be done by a model, which may be based on linear programming techniques.

At step 302, in an example, the model may receive a plurality of data inputs from disparate data sources within an enterprise supply chain (for example, databases, distribution centers, users, couriers, origin ports, Decons, gateways, overseas vendors, or others).

In some examples, the data inputs may include definitions of each node (of a plurality of nodes) within the enterprise supply chain, where nodes may include some or all of: overseas vendors, gateways, distribution centers, Decons, stores, or other appropriate supply chain entities. In some examples, gateways may include ports adapted to intercept (or send off) incoming (or outgoing) cargo vessels. In some examples, each definition may include at least a geographic region or location of the node and an active status of the node.

In some examples, the data inputs may include costs associated with processing of products at each node. In some examples, the data inputs may include route costs associated routes between various nodes. In some examples, data inputs may include cost data related to routes. In some examples, routes may be between overseas vendors and gateways, gateways and deconsolidators, and/or deconsolidators and distribution centers. In some examples, each deconsolidator may be associated with a gateway.

In some examples, the data inputs may include lead times associated with one or more routes. In some examples, the data inputs may include lead times associated with processing or deconsolidating products at nodes.

In some examples, the data inputs may include one or more shipping constraints (for example, capacity constraints, flow-conservation constraints, scheduling constraints, ability inability to pass a product type, or other relevant constraints), associated with one or more routes one or more gateways, one or more distribution center, one or more deconsolidator, one or more origin ports, one or more couriers, or one or more other nodes in the supply chain.

In some examples, the data inputs may include origin port product volume data representative of a schedule of retail goods, which may be provided by one or more of the overseas vendors. In some examples, the data inputs may include demand volume data indicative of a portion of the origin port product volume required to be received at each of the plurality of domestic distribution centers (for example, the volume required in order to ultimately fulfill downstream retail orders). In some examples, the schedule of retail goods may be based on a user-definable timeframe (for example, weekly, bi-weekly, monthly, quarterly, yearly, a specified number of weeks or other time periods, etc.).

In some examples, the model may predict a plurality of alternative data inputs based on past freight routing performances. In some examples, one or more of the data inputs may be modified based on the alternative data inputs to generate a plurality of modified data inputs. In some examples, the alternative data inputs may include alternate lead times associated with the routes and/or alternate lead times associated with the one or more shipping constraints. In some examples, alternate lead times may be of a longer or shorter duration than the original lead times.

At step 304, in an example, an optimization process may be executed by providing the data inputs to a linear solver model to generate a routing solution that is optimized to satisfy at least one user-selectable optimization goal. In some examples, the user-selectable optimization goal is cost minimization or lead time minimization. In some examples, the user-selectable optimization goal may include meeting demand volume. In some examples, the user-selectable optimization goal may include balancing cost minimization and lead time minimization, so that the optimized routing solution may not have the lowest possible cost or lowest possible route, but may instead provide a benefit to both, for example, in a situation where ultimate cost minimization results in higher lead times, or vice versa.

At step 306, in an example, outputs may be generated, on an origin node to destination node basis, for each origin node to destination node pairs within the enterprise supply chain. In some examples, outputs may include an optimized set of shipments through the plurality of gateways and accounting for the one or more shipping constraints. In some examples, the outputs may include cost data associated with the routing solution, lead time data associated with the routing solution, optimized volumes associated with the solution, or other relevant output data. In some examples, the outputs may be displayed via a user interface to a user. In some examples, the user interface is in a spreadsheet or table format.

At step 308, a determination of an optimized overseas freight strategy may be made based on the routing solution. In some examples, the optimized overseas freight strategy may include determining which routes or nodes to utilize. In some examples, the optimized overseas freight strategy may include removal of one or more gateways from the enterprise supply chain, to generate a revised routing solution that is further optimized relative to the routing solution. For example, a revised routing solution may show that a gateway previously utilized has been removed from the solution.

In some examples, a model may receive a second plurality of data inputs from the disparate data sources within the enterprise supply chain and may execute a second optimization process by providing the second data inputs to the linear solver model to generate a second routing solution that is optimized to satisfy the at least one user-selectable optimization goal. The model may output, on an origin node to destination node basis, for each of origin node to destination node pairs within the enterprise supply chain, a second plurality of data outputs. In some examples, the model may determine, based on the second optimization process, that integration of one or more additional expansion gateways, in addition to the plurality of current gateways, may generate a revised routing solution that is further optimized relative to the routing solution. For example, the revised routing solution may show that a gateway which was previously not utilized has been added or marked as “active” to the solution. In some examples, the model may output a recommendation to integrate the expansion gateway into the enterprise supply chain.

In some examples, input data from various sources may change over time. In those situations, the model can also be rerun with different data inputs. In some examples, the outputs from different scenarios may be compared, and the user may determine how a given change impacts each route of the supply chain, thereby seeing the benefits and overall effects of the change. In some examples, the user may then use this output data when determining the optimized overseas freight strategy, such as when determining whether to open a new gateway, change from one gateway to another, choose a different route, eliminate a gateway, or when negotiating with third-parties regarding the supply chain.

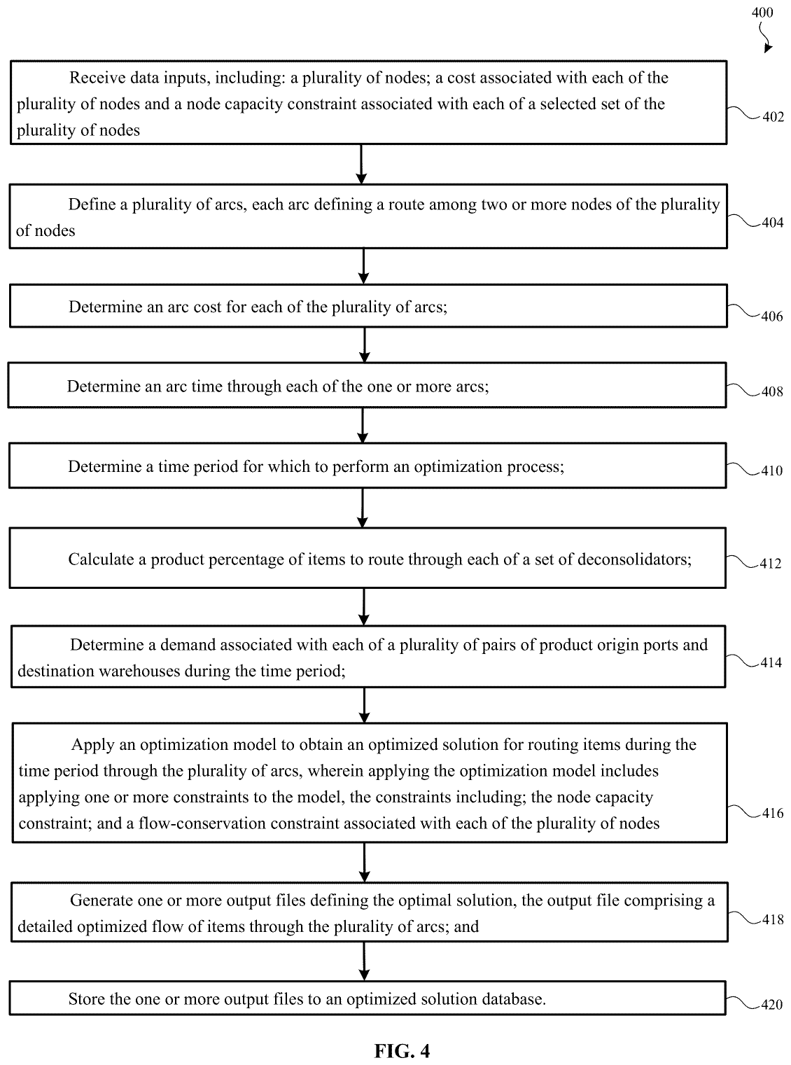

FIG. 4 illustrates an example method of optimizing a supply chain product route as carried out by an order management system software model, according to an example. As will be described in more detail below, the method 400 may include steps 402, 404, 406, 408, 410, 412, 414, 416, 418, and 420.

At step 402, a plurality of data inputs may be received from disparate data sources within an enterprise supply chain. In some examples, the inputs may include nodes, cost(s) associated with each node, and/or capacity constraint(s) associated with nodes or sets of nodes (for example, a group of selected gateways or ports). Nodes may include gateways, ports, deconsolidators, warehouses, or other appropriate facilities or locations. In some examples, costs may include a handling cost associated with a node. In some examples, a capacity constraint may be associated with one or more deconsolidators associated with a selected set of nodes.

At step 404, arcs may be defined, each arc defining a route between two or more nodes (for example, from one gateway/port to another gateway/port). In some examples, each arc may include a gateway node or port.

At step 406, a cost may be determined for each arc defined.

At step 408, a time may be determined for each arc, which may define the time it takes for items (goods, products, etc.) to move through each of the arcs in accordance with a transit mode of the items.

At step 410, a time period may be determined for which to perform an optimization process.

At step 412, a product percentage is calculated which may relate to the percentage of items to be routed through each deconsolidator.

At step 414, a demand associated with pairs of product origin ports and destination warehouses during the time period is determined.

At step 416, an optimization model is applied to obtain an optimized solution for routing items through the plurality of arcs during the previously determined time period. In some examples the optimized solution may have a goal which is a goal from multiple configurable objectives, which may include minimizing total costs and minimizing total lead times. In some examples, the optimization model may be a multivariable linear optimization model. In some examples, total costs may include total transportation costs associated with each arc (e.g. route) and/or total node variable costs associated with each arc. In some examples, total lead times may include arc times for each of the arcs (e.g., routes). In some examples, the goal may include balancing total costs and total lead times, so that one or both are not absolutely minimized, but the overall balanced effect is minimized. In some examples, the configurable objectives may be user-selectable. In some examples, the goal includes achieving a destination warehouse demand (in some examples, the portion of an origin port product volume which is required to be received at a domestic distribution center).

In some examples, prior to applying the optimization model, one or more constraints may be applied to the model. In some examples, constraints may include the node capacity constraint and/or a flow-conservation constraint associated with each node, which may include: source constraints associated with one or more of the nodes which are a source of items; intermediate constraints associated with a desired minimum flow through one or more nodes; and/or demand constraints associated with one or more of the nodes which are a destination of items.

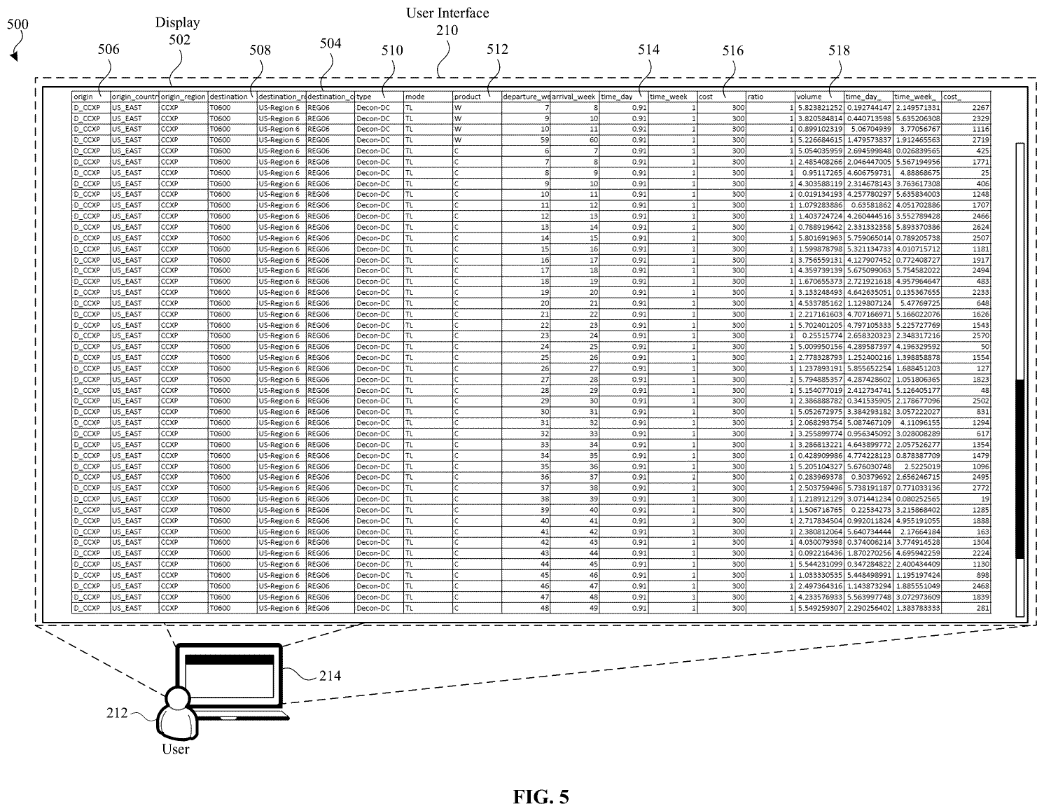

At step 418 one or more output files may be generated which may define the optimal solution. In some examples, the output file may include a detailed optimized flow of items through the arcs. In some examples, a display which includes the output file may be generated on a device for a user. An example of such a display is discussed in more detail in FIG. 5. In some examples, the output file(s) may include files that include one or more solution files which include the entirety of the optimal solution. In some examples, the solution files may include, for each deconsolidator, a deconsolidator file specific to that deconsolidator, which may define destinations, arrival times, costs, and volumes of items to be handled by that deconsolidator. In some examples, the output file(s) further includes a port-to-port file which may define total volumes (which may be measured, in some examples, as a percentage or portion of a shipping container volume) moved between export ports and gateway nodes. In some examples, the output file(s) further includes a file summarizing unserved demand based on the optimal solution, the unserved demand including one or both of (1) output demand or (2) a minimum gateway or deconsolidator capacity. In some examples, the output file display may be in a spreadsheet format.

At step 420, the generated output file(s) may be stored to an optimized solution database.

In some examples, the optimized solution may be implemented by deploying the output file(s) to a supply chain management system that automatically controls item movements throughout the enterprise supply chain. In some examples, the number, utilization, or designation of arcs may be updated based, at least in part, on detecting a change in an active status of one of the gateway nodes. In some examples, this change in an active status of a gateway node may be automatically detected, for example, if the model determines that a particular gateway node will be at or over capacity. In other examples, this change in an active status of a gateway node may be initiated by a user, for example, a user changing the active status of a gateway node to “active” when it previously was “inactive,” or vice versa.

FIG. 5 illustrates an example output display of an optimized supply chain routes as optimized by an order management system software model, according to an example. As will be described in more detail below, the system 500 may include user interface 210, user 212, device 214, display 502, output 504, origin 506, destination 508, type 510, product 512, time 514, cost 516, and volume 518.

In some examples, output 504 as described herein may be displayed as display 502 to user 212 as all or part of user interface 210 on device 214. In some examples, display 502 may be one or more spreadsheets, tables, graphs, or other appropriate means to view data associated with output 504. In some examples, user interface 210 allows user 212 to interact with display 502 to better view that data, adjust the data, compare data, or other customizations based off of user 212's preferences (for examples, filtering, sorting, customizing views and charts, toggling options on an off, or other similar operations). In some examples, data from different scenarios (for example, different outputs 504) may be compared on one display 502.

In some examples, output 504 may include data regarding origin 506 (in some examples, the beginning or source node of a route or arc as described herein, for example: suppliers, ports, gateways, deconsolidators, or other origin nodes) and destination 508 (in some examples, the end or destination node of a route or arc as described herein, for example: ports, gateways, deconsolidators, warehouses, or other destination nodes) of items (e.g. products or goods). In some examples, data is displayed on an origin-to-destination pair basis. In some examples, an origin-to-destination pair may partially or wholly define an arc or route. In some examples, output 504 may include data regarding the type 510 of a node and/or the product 512 (in some examples a type or category of product/good/item, shipping container (which may be carrying the product/good/item), or other relevant information). In some examples, output 504 may include data regarding the time 514 it will take for an arc/route to be completed, and/or one (or more) cost 516 associated with that arc/route. Some examples may include a volume 518 (e.g. volume of goods or volume as a percentage of a shipping container) of items to be moved along the route/arc.

In some examples, output 504 may include other data as necessary, such as modes, time 514 presented in different time intervals, ratios, other calculated variables and data as is needed by user 212.

For example, output 504 may include the optimal container volume 518 sent on each route and what the cost 516 and time 514 are for doing so. This data can then be separated, aggregated, or arranged for analysis. For example, the data can be arranged to show the optimal total cost or time for products shipped to a particular geographic region or over a certain time frame. Furthermore, the data can show the optimal inflow of each gateway; that is, the data can show the container volume that each gateway should receive, and where those containers should come from. User 212 may use output 504 data as displayed on user interface 210 when making strategic investment decisions, or other business decisions for the enterprise.

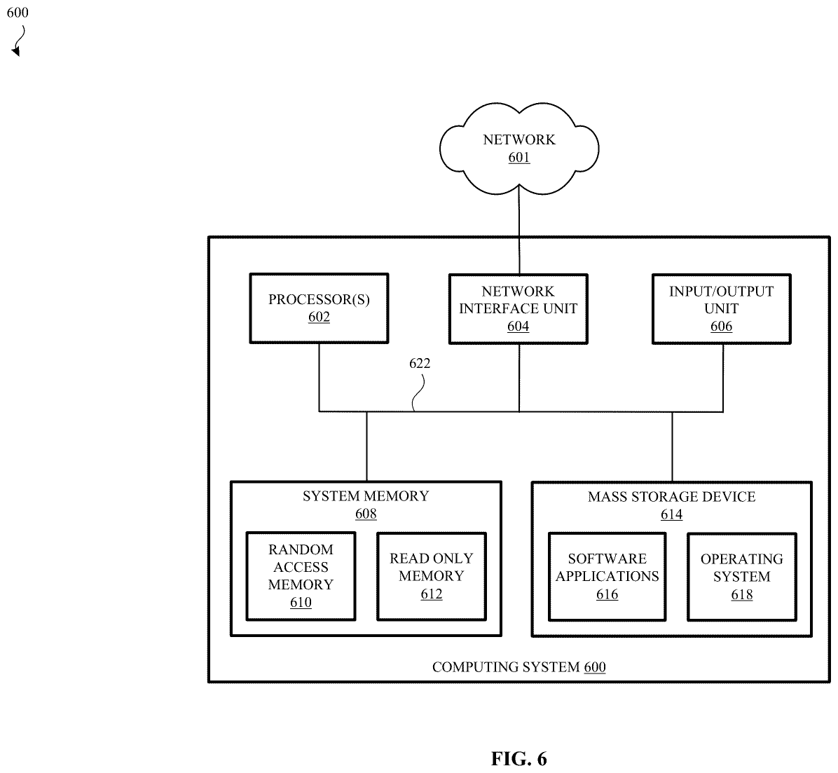

FIG. 6 illustrates an example block diagram of a virtual or physical computing system 600. One or more aspects of the computing system 600 can be used to implement the order management system software model 204, store instructions described herein, and preform operations described herein.

In the embodiment shown, the computing system 600 includes one or more processors 602, a system memory 608, and a system bus 622 that couples the system memory 608 to the one or more processors 602. The system memory 608 includes RAM (Random Access Memory) 610 and ROM (Read-Only Memory) 612. A basic input/output system that contains the basic routines that help to transfer information between elements within the computing system 600, such as during startup, is stored in the ROM 612. The computing system 600 further includes a mass storage device 614. The mass storage device 614 is able to store software instructions and data. The one or more processors 602 can be one or more central processing units or other processors.

The mass storage device 614 is connected to the one or more processors 602 through a mass storage controller (not shown) connected to the system bus 622. The mass storage device 614 and its associated computer-readable data storage media provide non-volatile, non-transitory storage for the computing system 600. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 600.

According to various embodiments of the invention, the computing system 600 may operate in a networked environment using logical connections to remote network devices through the network 601. The network 601 is a computer network, such as an enterprise intranet and/or the Internet. The network 601 can include a LAN, a Wide Area Network (WAN), the Internet, wireless transmission mediums, wired transmission mediums, other networks, and combinations thereof. The computing system 600 may connect to the network 601 through a network interface unit 604 connected to the system bus 622. It should be appreciated that the network interface unit 604 may also be utilized to connect to other types of networks and remote computing systems. The computing system 600 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the computing system 600 can store software instructions and data. The software instructions include an operating system 618 suitable for controlling the operation of the computing system 600. The mass storage device 614 and/or the RAM 610 also store software instructions, that when executed by the one or more processors 602, cause one or more of the systems, devices, or components described herein to provide functionality described herein. For example, the mass storage device 614 and/or the RAM 610 can store software instructions that, when executed by the one or more processors 602, cause the computing system 600 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of supply chain optimization, technologies disclosed herein are applicable to data structures and enterprises generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computing system, comprising:
at least one processor; and
at least one memory storing computer-executable instructions for optimizing overseas freight routing from a plurality of overseas vendors to a plurality of domestic distribution centers of a retail enterprise through one or more of a plurality of gateways, the computer-executable instructions, when executed by the at least one processor, causing the computer to:
receive a plurality of data inputs from disparate data sources within an enterprise supply chain, wherein the plurality of data inputs comprise:
a definition of each node of a plurality of nodes within the enterprise supply chain, the plurality of nodes including the plurality of overseas vendors, the plurality of gateways, and the plurality of domestic distribution centers, wherein each definition includes a geographic region and an active status of the node;
route costs associated with each of a plurality of routes comprising:
routes between the plurality of overseas vendors and each of the plurality of gateways; and
routes between a plurality of deconsolidators and the plurality of domestic distribution centers, wherein each deconsolidator is associated with one of the plurality of gateways;
lead times associated with each of the plurality of routes;
one or more shipping constraints associated with:
at least one route of the plurality of routes;
at least one gateway of the plurality of gateways;
at least one domestic distribution center of the plurality of domestic distribution centers; or
at least one deconsolidator of the plurality of deconsolidators;
origin port product volume data representative of a schedule of retail goods provided by one or more of the plurality of overseas vendors; and
demand volume data indicative of a portion of the origin port product volume required to be received at one or more of the plurality of domestic distribution centers;
executing an optimization process by determining a solution, via a linear solver model, based on the plurality of data inputs to generate a routing solution that is optimized to satisfy at least one user-selectable optimization goal;
outputting, on an origin node to destination node basis, for each of a plurality of origin node to destination node pairs within the enterprise supply chain, a plurality of data outputs, wherein the plurality of data outputs comprises, as part of the routing solution:
a set of origin node to destination node pairs including an optimized set of shipments through the plurality of gateways and accounting for the one or more shipping constraints including capacity constraints of the at least one gateway of the plurality of gateways;
cost data associated with the routing solution; and
lead time data associated with the routing solution; and
determining, based on the routing solution, an optimized overseas freight strategy.

2. The computing system of claim 1, wherein the at least one user-selectable optimization goal comprises at least one of cost minimization or lead time minimization.

3. The computing system of claim 1, wherein the at least one user-selectable optimization goal is balanced between a cost minimization goal and a lead time minimization goal.

4. The computing system of claim 3, wherein the cost minimization goal comprises the minimization of the route costs associated with each of a plurality of routes; and wherein the lead time minimization goal comprises the minimization of the lead times associated with each of the plurality of routes.

5. The computing system of claim 1, wherein the at least one user-selectable optimization goal comprises achieving the portion of the origin port product volume required to be received at each of the plurality of domestic distribution centers.

6. The computing system of claim 1, the computer executable instructions further causing the at least one processor to: display the data outputs to a user via a spreadsheet.

7. The computing system of claim 1, wherein the optimized overseas freight strategy comprises integration of an expansion gateway, in addition to the plurality of gateways, to generate a revised routing solution that is further optimized relative to the routing solution.

8. The computing system of claim 1, wherein the optimized overseas freight strategy comprises removal of one or more of the plurality of gateways from the enterprise supply chain, to generate a revised routing solution that is further optimized relative to the routing solution.

9. The computing system of claim 1, wherein the plurality of routes further comprise routes between each of the plurality of gateways and its associated deconsolidator, and wherein the plurality of gateways include ports adapted to intercept incoming cargo vessels.

10. The computing system of claim 1, the computer executable instructions further causing the at least one processor to:
receive a second plurality of data inputs from the disparate data sources within the enterprise supply chain;
executing a second optimization process by providing the second plurality of data inputs to the linear solver model to generate a second routing solution that is optimized to satisfy the at least one user-selectable optimization goal;
outputting, on the origin node to destination node basis, for each of the plurality of origin node to destination node pairs within the enterprise supply chain, a second plurality of data outputs;
determining, based on the second optimization process, that integration of an expansion gateway, in addition to the plurality of gateways, will generate a revised routing solution that is further optimized relative to the routing solution; and
outputting a recommendation to integrate the expansion gateway into the enterprise supply chain.

11. The computing system of claim 10, further comprising exporting the revised routing solution to an overseas transportation management system external to the computing system, wherein, upon implementing the revised routing solution, the overseas transportation management system automatically initiates routes via the expansion gateway.

12. The computing system of claim 10, wherein the schedule of retail goods is based on a user-definable timeframe.

13. The computing system of claim 12, wherein the schedule of retail goods is based on a weekly timeframe.

14. A computing system, comprising:
at least one processor; and
at least one memory storing computer-executable instructions for optimizing overseas freight routing from a plurality of overseas vendors to a plurality of domestic distribution centers of a retail enterprise through one or more of a plurality of gateways, the computer-executable instructions when executed by the at least one processor causing the computer to:
receive a plurality of data inputs from disparate data sources within an enterprise supply chain, wherein the plurality of data inputs comprise:
a definition of each node of a plurality of nodes within the enterprise supply chain, the plurality of nodes including the plurality of overseas vendors, the plurality of gateways, and the plurality of domestic distribution centers, wherein each definition includes a geographic region and an active status of the node;
route costs associated with each of a plurality of routes comprising:
routes between the plurality of overseas vendors and each of the plurality of gateways; and
routes between a plurality of deconsolidators and the plurality of domestic distribution centers, wherein each deconsolidator is associated with one of the plurality of gateways;
lead times associated with each of the plurality of routes;
one or more shipping constraints associated with:
at least one route of the plurality of routes;
at least one gateway of the plurality of gateways;
at least one domestic distribution center of the plurality of domestic distribution centers; or
at least one deconsolidator of the plurality of deconsolidators;
origin port product volume data representative of a schedule of retail goods provided by one or more of the plurality of overseas vendors; and
demand volume data indicative of a portion of the origin port product volume required to be received at each of the plurality of domestic distribution centers;
predicting a plurality of alternative data inputs based on past freight routing performances;
modifying one or more of the plurality of data inputs based on the plurality of alternative data inputs to generate a plurality of modified data inputs;
executing an optimization process by providing the modified plurality of data inputs to a linear solver model to generate a routing solution that is optimized to satisfy at least one user-selectable optimization goal;
outputting, on an origin node to destination node basis, for each of a plurality of origin node to destination node pairs within the enterprise supply chain, a plurality of data outputs, wherein the plurality of data outputs comprise:
an optimized set of shipments through the plurality of gateways and accounting for the one or more shipping constraints;
cost data associated with the routing solution; and
lead time data associated with the routing solution; and
determining, based on the routing solution, an optimized overseas freight strategy.

15. The computing system of claim 14, the plurality of alternative data inputs comprising at least one of: alternate lead times associated with one or more of the plurality of routes, or alternate lead times associated with the one or more shipping constraints.

16. The computing system of claim 15, wherein the alternate lead times are of a longer duration than the lead times.

17. A method for optimizing freight routing, comprising:
receiving a plurality of data inputs from disparate data sources within an enterprise supply chain, the plurality of inputs including:
a plurality of nodes;
a cost associated with each of the plurality of nodes, the cost comprising a handling cost associated with a corresponding one of the plurality of nodes; and
a node capacity constraint associated with each of a selected set of the plurality of nodes being representative of a group of selected gateways, the node capacity constraint being a capacity constraint of each of a set of deconsolidators associated with the selected set of the plurality of gateway nodes;
defining a plurality of arcs, each arc defining a route among two or more nodes of the plurality of nodes, each of the plurality of arcs defining the route including a gateway node of the plurality of gateway nodes;
determining an arc cost for each of the plurality of arcs;
determining an arc time defining a time of movement of items through each of the one or more arcs in accordance with a transit mode of the items;
determining a time period for which to perform an optimization process;
calculating a product percentage of items to route through each deconsolidator if the set of deconsolidators;
determining a demand associated with each of a plurality of pairs of product origin ports and destination warehouses during the time period;
applying an optimization model to obtain an optimized solution for routing items during the time period through the plurality of arcs, the optimized solution having a selectable goal from a plurality of configurable objectives, the plurality of configurable objectives including minimizing total costs and minimizing total lead times, the optimization model being a multivariable linear optimization model;
wherein total costs comprise total transportation costs associated with each of the plurality of arcs and total node variable costs associated with each of the plurality of arcs, and wherein total lead times comprise arc times for each of the plurality of arcs; and
wherein applying the optimization model includes applying one or more constraints to the model prior to applying the optimization model, the constraints including:
the node capacity constraint; and
a flow-conservation constraint associated with each of the plurality of nodes, the flow-conservation constraint comprising one or more of:
source constraints associated with one or more of the plurality of nodes which ae a source of items;
intermediate constraints associated with a desired minimum flow through one or more of the plurality of nodes; and
demand constraints associated with one or more of the plurality of nodes which are a destination of items; and
generating one or more output files defining the optimal solution, the output file comprising a detailed optimized flow of items through the plurality of arcs; and
storing the one or more output files to an optimized solution database.

18. The method of claim 17, further comprising generating a display for a user, the display comprising the one or more output files.

19. The method of claim 17, further comprising implementing the optimized solution, wherein implementing the optimized solution comprises deploying the one or more output files to a supply chain management system that automatically controls item movements throughout the enterprise supply chain.

20. The method of claim 17, wherein the one or more output files comprises a plurality of files including a solution file including an entirety of the optimal solution and, for each of the set of deconsolidators, a deconsolidator file specific to that deconsolidator, the deconsolidator file defining destinations, arrival times, costs, and volumes of items to be handled by that deconsolidator.

21. The method of claim 17, wherein the one or more output files further includes a port to port file defining total volumes moved between export ports and each of the plurality of gateway nodes.

22. The method of claim 17, wherein the one or more output files further includes a file summarizing unserved demand based on the optimal solution, the unserved demand including one of (1) output demand or (2) a minimum gateway or deconsolidator capacity.

23. The method of claim 17, further comprising updating the plurality of arcs based, at least in part, on detecting a change in an active status of one of the plurality of gateway nodes.
